(19) United States
(12) Patent Application Publication
(10) Pub. No.: US 2013/0001239 A1
(43) Pub. Date: Jan. 3, 2013

(54) AUTOMATIC DELIVERY OF ADHESIVE TO AN ADHESIVE SUPPLY UNIT AND SYSTEMS THEREFORE

(75) Inventors: Glenn C. Heuer, Forest Lake, MN (US); Steven A. Jorissen, Vadnais Heights, MN (US)

(73) Assignee: H.B. Fuller Company, St. Paul, MN (US)

(21) Appl. No.: 13/523,269

(22) Filed: Jun. 14, 2012

Related U.S. Application Data
(60) Provisional application No. 61/502,108, filed on Jun. 28, 2011.

(51) Int. Cl. B05C 11/10; G07F 9/10

(52) U.S. Cl. 221/1; 221/119; 221/150 A

(57) ABSTRACT

A system that includes an adhesive storage unit, the adhesive storage unit configured to separately hold a plurality of solid adhesive forms; a liquid adhesive level detector configured to sense the level of liquid adhesive in a liquid adhesive melt tank; and a delivery element configured to deliver solid adhesive forms stored in the adhesive storage unit to the liquid adhesive melt tank when necessary as indicated by the liquid adhesive level detector.

### CROSS-REFERENCE TO RELATED APPLICATIONS

This application claims the benefit of U.S. Provisional Application No. 61/502,108, filed on Jun. 28, 2011 and incorporated herein.

### FIELD

The present disclosure relates to automatic delivery methods and systems for delivering adhesive to a hot-melt adhesive supply unit.

### BACKGROUND

Hot-melt adhesives are extensively used in the production of numerous consumer products. Some of these consumer product lines operate at very high speeds and therefore require the constant delivery of significant quantities of adhesive. Users can struggle with the constant delivery of such large quantities; and failing to keep the system stocked with adhesive can cause significant negative consequences. Automated delivery systems do not function well with hot-melt adhesives, in particular hot melt pressure sensitive adhesives, because such adhesives can often become tacky and stick to automated delivery equipment, thereby causing disruptions in the automated delivery system.

Therefore, there remains a need for new methods of automatically delivering hot-melt adhesives to supply lines.

### SUMMARY

Disclosed herein are systems that include an adhesive storage unit, the adhesive storage unit configured to separately hold a plurality of solid adhesive forms; a liquid adhesive level detector configured to sense the level of liquid adhesive in a liquid adhesive melt tank; and a delivery element configured to deliver solid adhesive forms stored in the adhesive storage unit to the liquid adhesive melt tank when necessary as indicated by the liquid adhesive level detector.

Also disclosed are methods that include the steps of sensing a level of liquid adhesive in a liquid adhesive melt tank; determining that the liquid adhesive melt tank is at or below an adhesive needed level; and delivering at least one solid adhesive form from an adhesive storage unit to the liquid adhesive melt tank, wherein the adhesive storage unit is configured to separately hold a plurality of solid adhesive forms

### BRIEF DESCRIPTION OF THE DRAWINGS

The disclosure may be more completely understood in consideration of the following detailed description of various embodiments of the disclosure in connection with the accompanying drawings, in which:

The figures are not necessarily to scale. Like numbers used in the figures refer to like components. However, it will be understood that the use of a number to refer to a component in a given figure is not intended to limit the component in another figure labeled with the same number.

FIG. 1A schematically depicts an exemplary system disclosed herein;

FIG. 1B schematically depicts an exemplary adhesive storage unit as disclosed herein;

FIG. 2 schematically depicts an exemplary system that includes optional components as disclosed herein;

FIG. 3 schematically depicts an exemplary system that includes optional components as disclosed herein; and

FIG. 4 illustrates a method as disclosed herein.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”.

“Exemplary” or “representative” is used in the sense of “for example” or “for the purpose of illustration”, and not in a limiting sense.

As used herein “top” and “bottom” are used in relation to each other and are generally defined based on gravity and the way in which the item being discussed is disposed with respect to gravity.

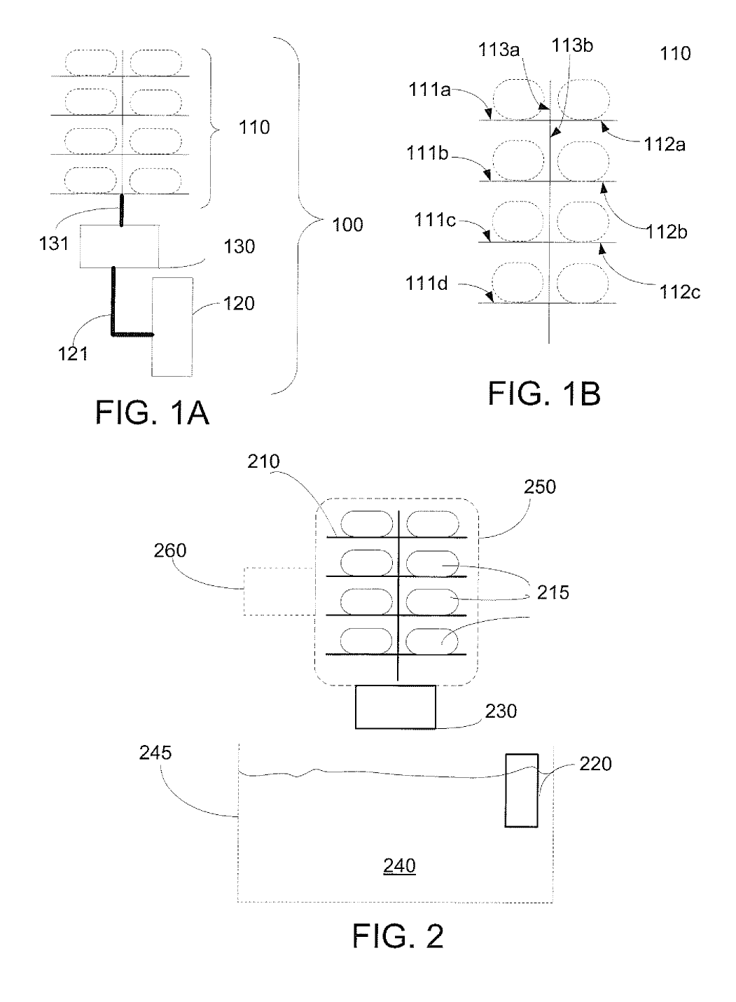

Disclosed herein are systems, which may or may not be part of a larger system. In embodiments, disclosed systems can provide automated delivery of hot-melt adhesives to adhesive supply units. Generally, a disclosed system can include an adhesive storage unit, a liquid adhesive level detector; and a delivery element. An example of a disclosed system is schematically depicted in FIG. 1A. The system 100 in FIG. 1A includes an adhesive storage unit 110, a liquid adhesive level detector 120, and a delivery element 130.

An adhesive storage unit 110, of which an example is depicted in FIG. 1B, can generally be configured to separately hold a plurality of solid adhesive forms. The phrase “separately hold” generally means that when being held in the adhesive storage unit, a solid adhesive form is not in contact with any other solid adhesive form. Separately holding solid adhesive forms can be advantageous for the automated delivery thereof because occasionally the solid forms, if contacting each other, especially when stored at elevated temperature, can be tacky enough to stick together. Solid form adhesives that may be sticking to one or more other solid form adhesives can be difficult to deliver; adhesive storage units as disclosed herein remedy such problems by preventing contact of the solid form adhesive units with each other.

Adhesive storage units 110 can generally hold a plurality of solid adhesive forms. In embodiments, an adhesive storage unit can be configured to hold from 2 to about 50 solid adhesive forms; in embodiments from 2 to 30 solid adhesive forms; and in embodiments from 5 to 20 solid adhesive forms. An adhesive storage unit can be configured to hold virtually any size solid adhesive forms. In embodiments, an adhesive storage unit can be configured to hold more than one size solid adhesive forms. In embodiments, an adhesive storage unit can be modified in order to hold different size solid adhesive forms. In embodiments, an adhesive storage unit can be configured to hold solid adhesive forms ranging from 0.5 pounds (lbs) to 20 lbs; in embodiments from 1 lb to 10 lbs; in embodiments from about 2 lbs to about 8 lbs; and in embodiments an adhesive storage unit can be configured to hold solid adhesive forms having a weight of about 5 lbs. The adhesive storage unit can be configured to hold various types of solid adhesive forms. Various commercially available solid adhesive forms could be used, including for example ZeroPack adhesive (H. B. Fuller, St. Paul, Minn.), Safemelt adhesive (Savaré, Milan, Italy), and Easy-Pac™ adhesive (Henkel, Dusseldorf, Germany)

An adhesive storage unit can be configured to hold any type of solid adhesive forms. In embodiments, the advantages of disclosed systems can be more fully realized when a disclosed system is used with hot-melt type solid adhesive forms, especially pressure sensitive hot melt solid adhesive forms. Generally, any type of hot-melt adhesives can be utilized along with disclosed systems. Exemplary polymer bases for hot melt adhesives that can be utilized herein include ethylene copolymers (including e.g. ethylene-vinyl acetate(EVA) copolymers, ethylene methyl methacrylate(EMMA) copolymers and ethylene-acrylate copolymers), polyolefins (including e.g. polyethylene, polypropylene, amorphous poly alpha olefins and metallocene catalyzed polyolefins), polyamides, polyesters, polyurethanes, styrene block copolymers, polycarbonates, fluropolymers, silicone rubbers, and polypyrrole for example.

Suitable styrene block copolymers include block copolymers having non-elastomeric endblocks of styrene and a rubbery mid-block of butadiene, isoprene, ethylene/propylene, ethylene/butylene and combinations thereof. Block copolymers are available in a variety of structures including e.g., A-B-A triblock structures, A-B diblock structures, (A-B)n radial block copolymer structures, and branched and functional versions thereof, wherein the A endblock can be a non-elastomeric polymer block that includes, e.g., polystyrene, vinyl or combinations thereof, and the B block can be an unsaturated conjugated diene or hydrogenated version thereof. Examples of suitable B blocks include isoprene, butadiene, ethylene/butylene (hydrogenated butadiene), ethylene/propylene (hydrogenated isoprene) and combinations thereof.

Hot-melt adhesives utilized herein can optionally include other components including e.g., tackifying resin, plasticizers (e.g. liquid plasticizers (e.g. oil), solid plasticizers, and combinations thereof), wax, fillers, pigments, superabsorbent, and antioxidants. In embodiments, an adhesive based on polymers such as styrene-butadiene block copolymers and polyolefins can be utilized in solid adhesive forms.

In embodiments, solid adhesive forms that can be utilized in disclosed systems can be adhesives that are applied at low temperatures. Exemplary adhesives that can be utilized as solid adhesive forms along with disclosed systems can be those that are applied at temperatures less than about 150° C.; or in embodiments can be those that are applied at temperatures less than about 120° C.

Adhesive storage units can be a single or multi part apparatus. In embodiments, an exemplary adhesive storage unit can be characterized by the surfaces thereof that can be in contact with the solid adhesive forms. Generally, the surfaces that can contact the solid adhesive forms can include both horizontal contact surfaces and vertical contact surfaces. FIG. 1B shows an example of an adhesive storage unit 110 that includes bottom horizontal contact surfaces 111a through 111d, which are those horizontal surfaces that can be contacted by the bottom of a solid adhesive form when the solid adhesive form is loaded into the adhesive storage unit. The adhesive storage unit 110 also includes top horizontal contact surfaces 112a through 112c, which are those horizontal surfaces that can be contacted by the top of a solid adhesive form when the solid adhesive form is loaded into the adhesive storage unit. A bottom horizontal contact surface can also be defined as the contact surface that is on the opposite side of a top horizontal contact surface. The exemplary adhesive storage unit 110 also includes vertical contact surfaces 113a and 113b. It should be noted that the number and configuration of horizontal and vertical contact surfaces can vary depending on the particular configuration of the adhesive storage unit. The embodiment and number of contact surfaces depicted in FIG. 1B is meant as exemplary only and should not be taken in a limiting fashion.

In embodiments, one or more of the horizontal or vertical contacting surfaces can include (for example can be made from or coated with) a material on which the solid adhesive form will not stick. In embodiments, only one or more (for example, all) the bottom horizontal contact surfaces can be made of a material on which the solid adhesive form will not stick. In embodiments, all of the bottom horizontal contact surfaces can be made of a material on which the solid adhesive form will not stick. In embodiments, only one or more (for example, all) the bottom and top horizontal contact surfaces can be made of a material on which the solid adhesive form will not stick. In embodiments, all of the bottom and top horizontal contact surfaces can be made of a material on which the solid adhesive form will not stick. In embodiments, at least a portion of all of the contact surfaces (for example both the bottom and top horizontal contact surfaces and the vertical contact surfaces) can be made of a material on which the solid adhesive form will not stick.

Materials which can be utilized for a portion of the contact surfaces of the adhesive storage unit can include for example, non-stick easy release surfaces, that can include for example fluorinated polymers such as polytetrafluoroethylene (PTFE) (also referred to as Teflon®); various coatings that are commercially provided by the Impreglon Corporation (Luneburg, Germany); or various types of metallic materials including for example dimpled metals.

The system 100 depicted in FIG. 1A can also include a liquid adhesive level detector 120. A liquid adhesive level detector 120 can generally function to monitor the quantity of liquid adhesive in a liquid adhesive melt tank (not pictured in FIG. 1A). Any commonly utilized type of level sensors can be utilized as liquid adhesive level detector 120, including for example floats (including both magnetic—for example magnetorestrictive sensors and resistive chain sensors, and mechanical floats), pneumatic level sensors, capacitive level sensors, optical sensors, ultrasonic level sensors, microwave sensors, hydrostatic pressure sensors, air bubbler sensors, gamma ray sensors, and weight based level sensors (for example monitoring the weight of the liquid adhesive holding container—as the level of liquid adhesive decreases, the weight also decreases). The particular way in which the liquid adhesive level detector 120 is configured within the liquid adhesive melt tank can depend at least in part on the capacity of the liquid adhesive melt tank, the type of the sensor, other considerations not discussed herein, or some combination thereof.

The liquid adhesive level detector 120 can be configured to monitor for at least an “adhesive needed level”. The “adhesive needed level” can generally be described as a level of liquid adhesive in the liquid adhesive melt tank at which more adhesive should be added. In embodiments, the adhesive needed level is above a level at which the liquid adhesive melt tank is empty of adhesive and below a level at which the liquid adhesive melt tank is full. In embodiments, the adhesive needed level can be a level at which the liquid adhesive melt tank is below capacity by at least about 0.1%; in embodiments it can be a level at which the liquid adhesive melt tank is below capacity by at least about 1%; in embodiments it can be a level at which the liquid adhesive melt tank is below capacity by at least about 5%; and in embodiments it can be a level at which the liquid adhesive melt tank is below capacity by 5% to 10%.

The liquid adhesive level detector 120 can also optionally be configured to monitor for other levels. In embodiments, the liquid adhesive level detector can be configured to monitor for an “emergency adhesive needed level”. The system could include a shut off if a solid adhesive form is not delivered to the liquid adhesive melt tank within a specified time frame (or a specified further decrease in the level of liquid adhesive) from the point at which the emergency adhesive needed level is detected. Such an optional level could be useful to prevent or minimize damage to the liquid adhesive melt tank or other components of an adhesive supply unit to which it is supplying adhesive; or to prevent or minimize products being manufactured using an adhesive supply unit from being incorrectly manufactured. In embodiments, the liquid adhesive level detector can be configured to monitor for an “excess adhesive level”. This is a level at which an excess of adhesive has been added to the liquid adhesive melt tank. Triggering this level could cause an alarm to sound, shut down the system, or both. Such an optional level could be useful to prevent or minimize damage to the liquid adhesive melt tank or other components of an adhesive supply unit to which it is supplying adhesive. Other optional levels could also be monitored for by the liquid adhesive level detector.

The system 100 depicted in FIG. 1A can also include a delivery element 130. The delivery element 130 generally functions to deliver solid adhesive forms that are stored in the adhesive storage unit to the liquid adhesive melt tank (not pictured in FIG. 1A). The delivery element 130 generally delivers a solid adhesive form (or forms) to the liquid adhesive melt tank when necessary as indicated by the liquid adhesive level detector 120.

Generally, the delivery element 130 can be connected to or configured with (which is schematically depicted as connection 131) the adhesive storage unit 110; and can be connected to or configured with (which is schematically depicted as connection 121) the liquid adhesive level detector 120. These connections allows the delivery element 130 to manipulate the adhesive storage unit 110 to deliver at least one solid adhesive from when indicated as proper by the liquid adhesive level detector 120. The connection 131 between the delivery element 130 and the adhesive storage unit 110 can be a mechanical connection, an electrical connection, or a combination thereof.

Generally, a delivery element 130 can include or be made up of more than one portion or piece. Exemplary delivery elements can generally include gears or gearing systems. Exemplary delivery elements can be configured to deliver solid adhesive forms at somewhat reproducible time intervals in order to maintain a particular level of liquid adhesive in the liquid adhesive melt tank. In such embodiments, the liquid adhesive level detector can instruct the delivery element if the delivery interval should be maintained or modified (either deliver faster or slower). In embodiments, the delivery element can include a slide that delivers the solid adhesive form to a spring loaded trap door such that as the solid adhesive form pushes on the door, it springs open and after the adhesive has passed through the door, the spring shuts.

Disclosed systems can be utilized in combination with adhesive supply units. Generally, an adhesive supply unit can refer to a system or systems that can be utilized to provide or deliver desired amounts of liquid adhesive to a manufacturing line for example. Exemplary commercially available adhesive supply units include for example those available from Robatech USA Inc. (Roswell, Ga.); Nordson Corporation (Duluth, Ga.); and ITW Dynatec (Hendersonville, Tenn.). Alternatively, an adhesive supply unit that can be utilized in methods herein can include at least one liquid adhesive melt tank, and at least one conduit to allow liquid adhesive from the melt tank to be delivered to an adhesive delivery port.

Systems as disclosed herein can be configured for use with or within other systems that include a liquid adhesive melt tank. An embodiment of a system that includes a liquid adhesive melt tank is shown in FIG. 2. The system depicted in FIG. 2 includes the components discussed above (adhesive storage unit 210, a liquid adhesive level detector 220, and a delivery element 230) and a liquid adhesive melt tank 245. The liquid adhesive melt tank 245 generally holds liquid adhesive 240. Generally, commonly utilized and available liquid adhesive melt tanks can be utilized herein. In embodiments, any type of liquid adhesive melt tank that can be configured along with a liquid adhesive level detector can be utilized herein. Exemplary melt tanks include those commercially available from Robatech USA Inc. (Roswell, Ga.); Nordson Corporation (Duluth, Ga.); and ITW Dynatec (Hendersonville, Tenn.) for example. In embodiments, liquid adhesive melt tanks can be configured with an optional cover.

The liquid adhesive melt tank 245 can generally have any desirable size or capacity of liquid adhesive 240. In embodiments, the size of the liquid adhesive melt tank can depend on the particular product that is being manufactured, the particular adhesive being utilized, other considerations not discussed herein, or combinations thereof. In embodiments, liquid adhesive melt tanks having capacities from 10 lbs to 1000 lbs can be utilized herein; in embodiments capacities from 10 lbs to 500 lbs can be utilized herein; in embodiments capacities from 20 lbs to 200 lbs can be utilized herein; and in embodiments capacities from 30 lbs to 100 lbs can be utilized herein.

In embodiments that include or are configured with a liquid adhesive melt tank 245, the adhesive storage unit 210 is generally configured in relation to the liquid adhesive melt tank 245 so that the solid adhesive form is delivered to the liquid adhesive melt tank 245 via the delivery element 230. In embodiments, the adhesive storage unit 210 is positioned above (or vertically above) the liquid adhesive melt tank 245. In embodiments, the adhesive storage unit can be positioned 1 inch to 2 feet above the liquid adhesive melt tank; in embodiments, the adhesive storage unit can be positioned 6 inches to I foot above the liquid adhesive melt tank. Positioning of the adhesive storage unit 210 above the liquid adhesive melt tank 245 can be advantageous for a number of reasons. If the distance between the adhesive storage unit and the liquid adhesive melt tank is too large, the solid adhesive forms may create excessive or undesirable splashes when dropped from the adhesive storage unit to the liquid adhesive melt tank. If the distance between the adhesive storage unit and the liquid adhesive melt tank is too little, the solid adhesive forms can be subjected to excessive or undesirable heating from the liquid adhesive melt tank. In embodiments, the adhesive storage unit 210 being positioned above the liquid adhesive melt tank 245 can be advantageous because it can conserve space in that additional “floor space” would not be necessary to incorporate a disclosed system into an existing adhesive supply unit.

Vertical positioning of the adhesive storage unit with respect to the liquid adhesive melt tank can also be advantageous in that such a configuration can utilize the force of gravity to assist in the delivery of the solid adhesive forms In embodiments, the solid adhesive form could in effect be resting on the bottom horizontal contact surface until the delivery element causes it to be inverted. This could be particularly advantageous for the delivery of pressure sensitive hot-melt adhesives, which are often tacky and therefore not amenable to air assisted delivery (as non-tacky products are). Gravity can also diminish the detrimental affect of friction, which in combination with a tacky item to be delivered can cause an automated delivery system to fail to deliver a form because it gets “stuck” in the system (the inversion of the solid adhesive form in particular embodiments could also diminish the possibility of the solid adhesive form getting “stuck”).

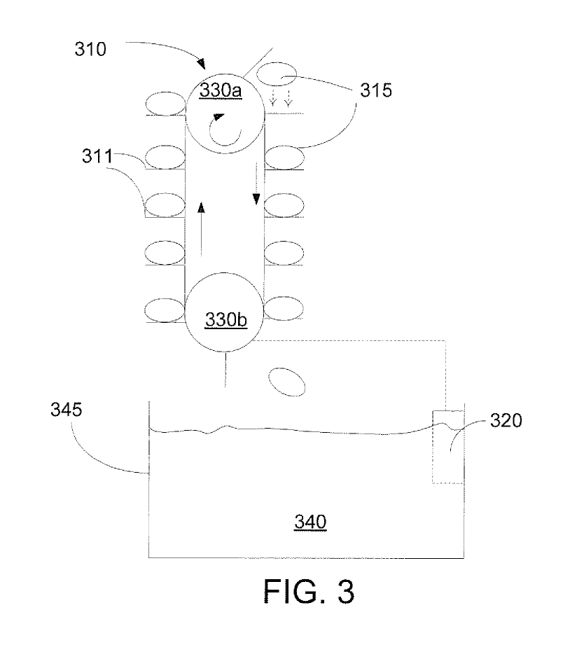

In embodiments, the solid adhesive forms are moved through the adhesive storage unit in a vertical direction as in FIG. 3 i.e. the delivery element moves the solid adhesive forms up and then down through the adhesive storage unit.

Systems as disclosed herein can also optionally include a heater configured to heat at least a portion of the interior of the adhesive storage unit. FIG. 2 depicts an exemplary embodiment that includes an optional adhesive storage unit heater 250. The heater 250 can include or be configured in combination with a cover, which covers at least a portion of the adhesive storage unit 210 from the external environment. An optional cover can also be advantageous by preventing or minimizing contaminants (for example dust or other environmental contaminants) from being included in the liquid adhesive. A heater as disclosed herein can also refer to an element or elements that can be utilized to heat individual portions of an adhesive storage unit. For example, individual surfaces of an adhesive storage unit could be heated; for example, bottom horizontal contact surfaces could be heated.

In embodiments, the adhesive storage unit can be heated differently in different areas, for example, the adhesive storage unit can be heated in one portion and not heated in another portion. In embodiments, the adhesive storage unit is only heated on one side such that it can be loaded on an unheated side and as the solid adhesive forms pass over the top, the solid adhesive forms would enter into the heated zone. In such an embodiment, a cover on the adhesive storage unit can optionally be transparent in the unheated zone so that a user can easily determine when the adhesive storage unit should be filled.

In general, a heater 250 can be configured to heat the interior of the adhesive storage unit, at least one of the plurality of the solid adhesive forms, or both to a temperature above room temperature. In embodiments, the heater can heat at least one of the solid adhesive forms (or each of the solid adhesive forms before it is delivered to the liquid adhesive melt tank) to at least about 35° C. In embodiments, the heater can heat at least one of the solid adhesive forms (or each of the solid adhesive forms before it is delivered to the liquid adhesive melt tank) to at least about 60° C. In embodiments, the heater can heat at least one of the solid adhesive forms (or each of the solid adhesive forms before it is delivered to the liquid adhesive melt tank) to its melting point, so that it is delivered to the liquid adhesive melt tank 245 as a liquid.

Systems as disclosed herein can also optionally include an adhesive storage unit level monitor. An adhesive storage unit level monitor can indicate to a user when additional solid adhesive forms should be added to the adhesive storage unit. FIG. 2 depicts an exemplary embodiment that includes an optional adhesive storage unit level monitor 260. The optional adhesive storage unit level monitor 260 can generally include numerous types of components. In embodiments, the adhesive storage unit level monitor can include an optical system, an electronic system that monitors the number of solid adhesive forms placed in and delivered from the adhesive storage unit, a system that utilizes information input from a user, a system that utilizes information gathered from other portions of the system or other systems, other types of systems, or some combination thereof.

In embodiments where an optional adhesive storage unit level monitor is included, the monitor can determine if or when an adhesive storage unit is at or below a “solid adhesive form needed level”. The “solid adhesive form needed level” can generally be described as a particular number of solid adhesive forms remaining, a particular time after which there will not be adhesive in the liquid adhesive melt tank, other times or numbers of solid adhesive forms, or some combination thereof. When the adhesive storage unit level monitor notes a “solid adhesive form needed level” the adhesive storage unit level monitor (or some other portion of the system or another system) can for example sound an alarm. The alarm can indicate to a user that more solid adhesive form should be added to the adhesive storage unit. Once this alarm is sounded (or alternatively based on some other monitoring system or user observation), a user can add additional solid adhesive forms to the adhesive storage unit.

Other optional components not discussed herein can also additionally be configured along with or within a disclosed system. For example, an adhesive storage unit could include a platform (located for example on one side of the adhesive storage unit) to assist a user in filling the adhesive storage unit.

FIG. 3 schematically depicts an exemplary system as disclosed herein. The exemplary system depicted in FIG. 3 includes an adhesive storage unit 310. The exemplary adhesive storage unit 310 can generally be a type of indexer that holds individual solid adhesive forms on shelves 311. The delivery element 330, of which there are at least the two depicted portions 330a and 330b is configured to turn the adhesive storage unit 310 so that the individual solid adhesive forms 315 are sequentially delivered to the liquid adhesive melt tank 345. As each of the shelves 311 go from the left side of the adhesive storage unit 310 to the right side, the solid adhesive form 315 held on a top horizontal contact surface of a shelf falls to the bottom horizontal contact surface of a second (or adjacent) shelf. The liquid adhesive level detector 320 monitors the level of liquid adhesive 340 in the liquid adhesive melt tank 345 and communicates with the delivery element 330 to determine or dictate the speed at which the solid adhesive forms 315 are delivered to the liquid adhesive melt tank 345. In an embodiment, at least one of the portions 330a and 330b can rotate (as indicated in FIG. 3) in order to move the shelves, separately holding the solid adhesive forms, so that each sequential solid adhesive form will ultimately be flipped into the liquid adhesive melt tank 345.

In embodiments, the adhesive storage unit can be configured so that the solid adhesive forms contact only the surfaces of the shelves on the indexer (or other analogous portions of the adhesive storage unit). In embodiments, the action of the delivery element alone (for example the action of the indexer) can cause a solid adhesive form to be delivered to the liquid adhesive tank. For example, the shelves of the indexer are not required to be aligned with any other component of the adhesive storage unit (or other device) to deliver a solid adhesive form. This can be advantageous for the delivery of hot melt adhesives, especially pressure sensitive hot melt adhesives, because it limits the surfaces that are contacted by the solid adhesive forms, thereby minimizing surfaces that the solid adhesive forms could detrimentally stick to.

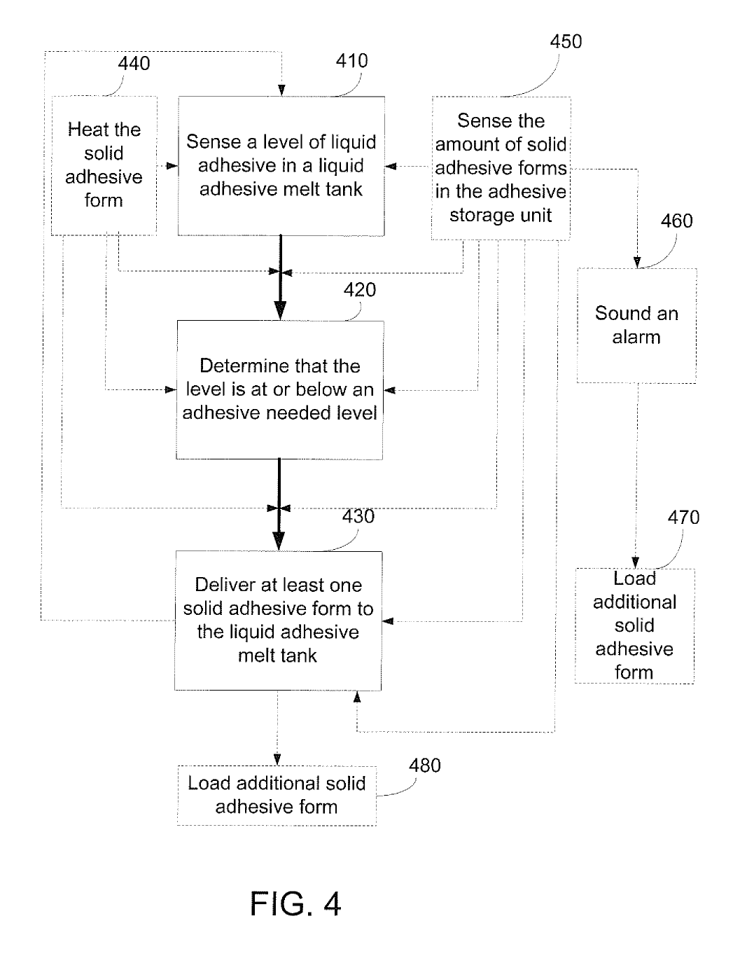

Methods of delivering solid adhesive forms are also disclosed herein. An exemplary method is depicted in the flowchart in FIG. 4. An exemplary method can include, step 410, sensing a level of liquid adhesive in a liquid adhesive melting tank; step 420, determining that the liquid adhesive melt tank is at or below an adhesive needed level; and step 430, delivering at least one solid adhesive form from an adhesive storage unit to the liquid adhesive melt tank. Methods as disclosed herein can also include additional steps, including steps disclosed herein and steps not disclosed herein. The steps can be accomplished in any order (that would not be contrary to the step itself), and can be undertaken once or more than once. The steps in the disclosed methods can be carried out, for example, using systems as described above.

The step of sensing the level of liquid adhesive in the liquid adhesive melting tank can be accomplished using any devices, electronics, methods, or combinations thereof for accomplishing such a step. In embodiments, the step of sensing the level of liquid adhesive in the liquid adhesive melt tank can be accomplished using magnetic float, a mechanical float, a pneumatic level sensor, a capacitive level sensor, an optical sensor, an ultrasonic level sensor, a microwave sensor, a hydrostatic pressure sensor, an air bubbler sensor, a gamma ray sensor, a weight based load cell level sensor, or some combination thereof. The step of determining whether the liquid adhesive is at or below an adhesive needed level can be accomplished using known methods and electronics, including for example use of a comparator, or other processor. The step of delivering at least one solid adhesive form to the liquid adhesive melt tank can be accomplished using methods, devices, or combinations thereof as described above. In embodiments, the step of delivering at least one solid adhesive form to the liquid adhesive melt tank can be accomplished by sliding a solid adhesive form from the adhesive storage unit, by depositing a solid adhesive form from the adhesive storage unit, by vertically dropping the solid adhesive form from the adhesive storage unit, or some combination thereof.

Disclosed methods can also include optional steps, such as for example, step 440, heating the solid adhesive form before they are delivered to the liquid adhesive melt tank. The step of heating the solid adhesive form (which can also be referred to as pre-heating the solid adhesive form) can be accomplished using a heater or an oven either alone or in combination with a cover for the adhesive storage unit. The particular temperature, time of heating, rate of heating, and combinations thereof can be determined at least in part based on the identity of the adhesive, the size of the solid adhesive form, the shape of the solid adhesive form, or combinations thereof. As seen in FIG. 4, the optional step of heating the solid adhesive forms before they are delivered to the liquid adhesive melt tank can be undertaken at any point before a particular solid adhesive form is delivered to the liquid adhesive melt tank. It should also be noted that the step of pre-heating the solid adhesive form can be constantly carried out and can begin once any particular solid adhesive form is placed in the adhesive storage unit.

Methods that include the optional step of pre-heating at least one solid adhesive forms can be advantageous when using adhesives that are applied at low temperatures (for example less than about 150° C. or in embodiments less than about 120° C.) because the addition of a pre-heated solid adhesive form (in comparison to a room temperature solid adhesive form) will not have as substantial an effect on the temperature of the liquid adhesive in the liquid adhesive melt tank. Addition of a room temperature solid adhesive form can substantially decrease the temperature of the liquid adhesive, which can detrimentally effect the adhesiveness qualities of the liquid adhesive and can therefore detrimentally effect products that can are made with such adhesive.

Another optional step includes for example, step 450, sensing the amount of solid adhesive forms in the adhesive storage unit. The step of sensing the amount of solid adhesive forms in the adhesive storage unit can be accomplished using methods, devices, and components as discussed above. As seen in FIG. 4, the optional step of sensing the amount of solid adhesive forms in the adhesive storage unit can be undertaken at any point in disclosed methods. It should also be noted that the step of sensing the amount of solid adhesive forms in the adhesive storage unit can be constantly carried out and can begin once any particular solid adhesive form is placed in the adhesive storage unit.

In embodiments where the optional step of sensing the amount of solid adhesive forms in the adhesive storage unit is undertaken, step 460, sounding an alarm can also be undertaken. In embodiments, an alarm can be sounded if the amount of solid adhesive forms in the adhesive storage unit is at or below a solid adhesive needed level. The particular amount of solid adhesive forms that constitutes a solid adhesive needed level can depend on various factors as discussed above. Various characteristics of the alarm to be sounded can depend on a number of factors.

Another optional step includes for example, step 470 (and step 480), loading at least an additional solid adhesive form into the adhesive storage unit. The optional step of loading at least an additional solid adhesive form into the adhesive storage unit can be undertaken in embodiments where the amount of solid adhesive forms in the adhesive storage unit is monitored (step 470) and in embodiments where the amount of solid adhesive forms in the adhesive storage unit is not monitored (step 480). The optional step of loading at least an additional solid adhesive form into the adhesive storage unit can be undertaken at any point in disclosed methods. It should also be noted that the step of loading at least an additional solid adhesive form into the adhesive storage unit can be constantly carried out and can begin once any particular solid adhesive form is placed in the adhesive storage unit.

Systems and methods disclosed herein can advantageously be utilized within other methods, such as in manufacturing methods. Specifically, disclosed systems and methods may be advantageously utilized in the manufacture of disposable articles, where large quantities of adhesives, such as pressure sensitive adhesives are commonly utilized. Exemplary types of disposable articles can include for example disposable diapers, feminine hygiene products, and incontinence management products.

Thus, embodiments of AUTOMATIC DELIVERY OF ADHESIVE TO AN ADHESIVE SUPPLY UNIT AND SYSTEMS THEREFORE are disclosed. One skilled in the art will appreciate that the leads, extensions, connectors, devices such as signal generators, systems and methods described herein can be practiced with embodiments other than those disclosed. The disclosed embodiments are presented for purposes of illustration and not limitation.

What is claimed is:

1. A system comprising:
an adhesive storage unit, the adhesive storage unit configured to separately hold a plurality of solid adhesive forms;
a liquid adhesive level detector configured to sense the level of liquid adhesive in a liquid adhesive melt tank; and
a delivery element configured to deliver solid adhesive forms stored in the adhesive storage unit to the liquid adhesive melt tank when necessary as indicated by the liquid adhesive level detector, wherein the solid adhesive forms move through the adhesive storage unit in a vertical direction.

2. The system according to claim 1 further comprising an adhesive storage unit heater.

3. The system according to claim 2, wherein the adhesive storage unit heater is configured to heat the solid adhesive forms to a temperature above room temperature.

4. The system according to claim 3, wherein at least one of the solid adhesive forms is heated to at least about 60° C.

5. The system according to claim 1, wherein the adhesive storage unit comprises solid adhesive form contact surfaces comprising Teflon®, Impreglon®, or dimpled metal.

6. The system according to claim 1 further comprising a liquid adhesive melt tank.

7. The system according to claim 6, wherein the adhesive storage unit is positioned vertically above the liquid adhesive melt tank.

8. The system according to claim 1, wherein the adhesive storage unit is configured to hold solid adhesive forms ranging from about 1 to about 10 pounds.

9. The system according to claim 1, wherein the adhesive storage unit is configured to hold from about 2 to about 30 solid adhesive forms.

10. The system according to claim 1, wherein the liquid adhesive level detector is a magnetic float, a mechanical float, a pneumatic level sensor, a capacitive level sensor, an optical sensor, an ultrasonic level sensor, a microwave sensor, a hydrostatic pressure sensor, an air bubbler sensor, a gamma ray sensor, a weight based load cell level sensor, or a combination thereof.

11. The system according to claim 1 further comprising an adhesive storage unit level monitor.

12. A method comprising:
sensing a level of liquid adhesive in a liquid adhesive melt tank;
determining that the liquid adhesive melt tank is at or below an adhesive needed level;
moving at least one solid adhesive form vertically through an adhesive storage unit; and
delivering at least one solid adhesive form from the adhesive storage unit to the liquid adhesive melt tank, wherein the adhesive storage unit is configured to separately hold a plurality of solid adhesive forms.

13. The method according to claim 12, wherein the sensing step is accomplished using a magnetic float, a mechanical float, a pneumatic level sensor, a capacitive level sensor, an optical sensor, an ultrasonic level sensor, a microwave sensor, a hydrostatic pressure sensor, an air bubbler sensor, a gamma ray sensor, a weight based level sensor, or some combination thereof.

14. The method according to claim 12 further comprising heating the solid adhesive forms above room temperature before they are delivered to the liquid adhesive melt tank.

15. The method according to claim 14, wherein the solid adhesive forms are heated to a temperature of at least about 35° C. before they are delivered to the liquid adhesive melt tank.

16. The method according to claim 12, wherein the delivering step is accomplished by vertically dropping the solid adhesive forms into the liquid adhesive melt tank.

17. The method according to claim 12 further comprising sensing the amount of solid adhesive forms in the adhesive storage unit.

18. The method according to claim 17 further comprising sounding an alarm if the adhesive storage unit is at or below a solid adhesive form needed level.

19. The method according to claim 12 further comprising loading additional solid adhesive forms into the adhesive storage unit.

20. A system comprising:
an adhesive storage unit, the adhesive storage unit configured to separately hold a plurality of solid adhesive forms;
a liquid adhesive level detector configured to sense the level of liquid adhesive in a liquid adhesive melt tank;
a delivery element configured to deliver solid adhesive forms stored in the adhesive storage unit to the liquid adhesive melt tank when necessary as indicated by the liquid adhesive level detector; and
an adhesive storage unit heater.
